(19) United States
(12) Patent Application Publication
(10) Pub. No.: US 2005/0184072 A1
(43) Pub. Date: Aug. 25, 2005

(54) Picture frame cup rest device

(76) Inventor: Odis Q. Kidd III, Columbus, OH (US)

Correspondence Address: DAVID A. GREENLEE, P. O. BOX 340557, COLUMBUS, OH, 43234-0557, US

(21) Appl. No.: 10/887,600

(22) Filed: Jul. 9, 2004

Related U.S. Application Data
(60) Provisional application No. 60/547,268, filed on Feb. 24, 2004.

(51) Int. Cl. B67D 5/62

(52) U.S. Cl. 220/476

(57) ABSTRACT

A device providing a place to rest a beverage container includes a back plate, a wall hangar, and a front plate hinged at its bottom to the back plate for movement between folded and unfolded positions extending from the back plate. A stop assures that the front plate extends approximately 90° from the back plate in the unfolded position. The front plate inner side serves as a horizontal rest for the beverage container when in unfolded position. The outer side of the front plate mounts a picture for display when the device is folded.

### CROSS-REFERENCE TO RELATED APPLICATION

This application claims priority of U.S. Provisional Application Ser. No. 60/547268.

### TECHNICAL FIELD

This invention relates to picture frames and to cup holders and, more particularly, to a combined picture frame and cup rest or holder.

### BACKGROUND OF THE INVENTION

It is common to serve beverages or drinks, such as coffee, soda pop or beer, in their containers, such as cups, glasses, bottles or cans, to household guests. When serving the drinks, the host/hostess must provide a place for the guests to safely set the drinks between sips, to enable the guests to play cards, shooting pool, playing foosball, computer games or the like activities.

Cold drinks usually “sweat” moisture, and it is necessary to provide coasters or other devices for placement on tables to protect the tables' finish from moisture marking. Similarly, the heat from hot drinks, such as coffee, can mar the finish of an unprotected table top. At many parties, the available table-top space is insufficient to hold all the guests' containers. Often, tables are inconveniently placed and spaced for ready access by the guests, most of whom stand and talk.

In addition, when guests play table games, such as cards, ping-pong, foosball, pool, etc., tables are, of necessity, not located near the action. So where are the guests to set their beverage containers? There is a need for a device to hold beverage containers that is convenient to guests, and is not dependent on the proximity of a table.

### SUMMARY OF THE INVENTION

It is an object of this invention to provide a device to hold beverage containers that is not dependent on the proximity of a table.

In one aspect, this invention features a device that provides a place to rest a beverage container which comprises a back plate, means for hanging the back plate on a wall, and a front plate hinged at its bottom to the back plate for movement between a folded position adjacent the back plate and an unfolded position extending from the back plate. Means are included for assuring that the front plate extends approximately 90° from the back plate in the unfolded position. Means are included for enabling the back plate to be hung on a wall. The front plate has an inner side suitable for serving as a horizontal rest for a beverage container when in unfolded position, and an outer side having means for mounting a picture for display when in the folded position.

Preferably, the front plate includes a safety lip for constraining a container placed thereon from sliding off the side of the front plate in unfolded position.

In another aspect, the outer side of the front plate includes feet for supporting the device atop a table, the outer side of the front plate includes means for mounting a picture, and the inner side of the back plate includes means for mounting a picture.

These and other objects and features of this invention will become more readily apparent upon reference to the following detailed description of a preferred embodiment, as illustrated in the accompanying drawings; in which:

### BRIEF DESCRIPTION OF THE DRAWINGS

FIG. 1 is a front view of a picture frame cup rest according to this invention, shown in unfolded position;

FIG. 2 is a view similar to FIG. 1, with a movable front plate shown in folded position;

FIG. 3 is a side view of the device shown in unfolded position;

FIG. 4 is a side view of the device shown in folded position;

FIG. 5 is a top view of the device shown in unfolded position;

FIG. 6 is a top view of the device shown in folded position;

FIG. 7 is an enlarged view of a wall hanger of the device;

FIG. 8 is an enlarged view of a wall spacer of the device; and

FIG. 9 is an enlarged view of the hinge of the device shown in unfolded position.

### DESCRIPTION OF THE PREFERRED EMBODIMENT

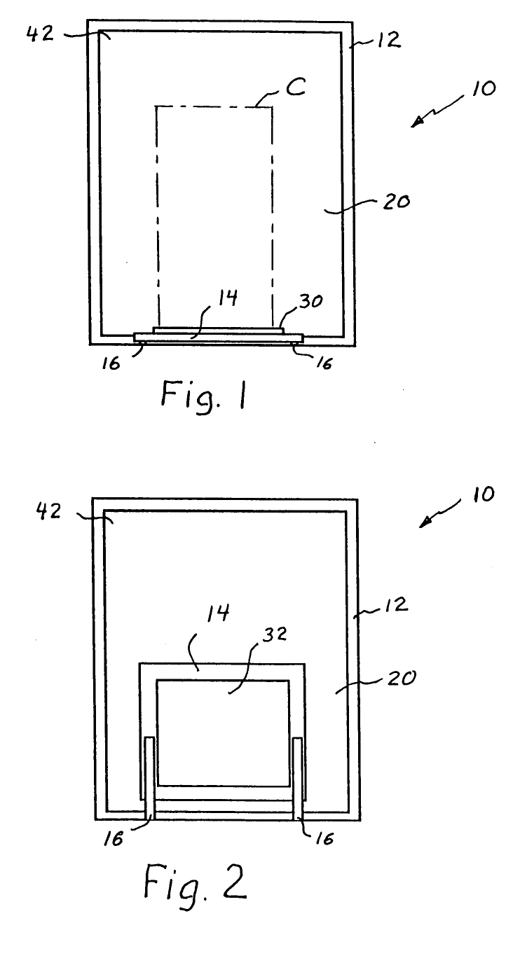

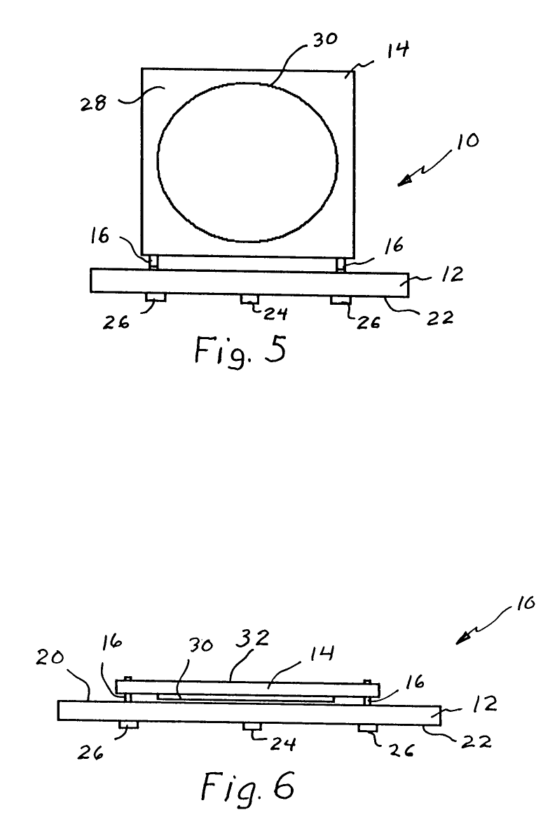

Referring to FIGS. 1-6, one embodiment of a picture frame cup rest device 10, according to this invention, includes a back plate 10 and a front plate 14 that are secured together by hinges 16, which allows plated 12 and 14 to move relative to each other between a folded position (FIGS. 2, 4 and 6), and an unfolded position (FIGS. 1, 3 and 5) in which they are positioned 90° relative to each other. Hinge 16 includes a short segment 17 secured to the bottom of back plate 12, and an L-shaped segment 18 secured to the bottom plate.

Back plate 12 has an inner surface 20 and an outer surface 22, which mounts a wall hanger 24 at its top and a pair of wall spacers 26 at its bottom. Wall spacer 26 is provided to assure that back plate 12 is hung vertically, so that front plate 14 is horizontal in its 90° unfolded position. As best seen in FIG. 2, front plate 14 has an inner side 28 that mounts a guard rim 30 about part of its periphery and an outer side that mounts a picture frame for mounting a photograph or other picture in a known manner.

Hinge segment 18 abuts the bottom of back plate 12 to limit unfolding movement of front plate 14 to position it 90° relative to back plate 12. As seen in FIG. 4, the dimension of the short leg of hinge segment 18 is such that rim 30 on bottom plate 14 lies flush with inner surface 20.

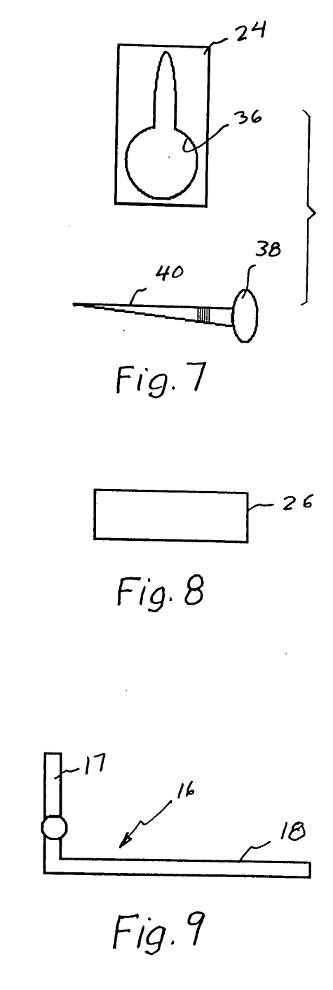

As shown in FIG. 7, wall hanger 24 includes a keyhole-shaped slot 36 that receives the head 38 of a screw 40 to mount device 10 on a wall. The inner side 20 of back plate 12 has means mounting a picture, which is fully visible in unfolded position to maintain the appearance of a picture frame.

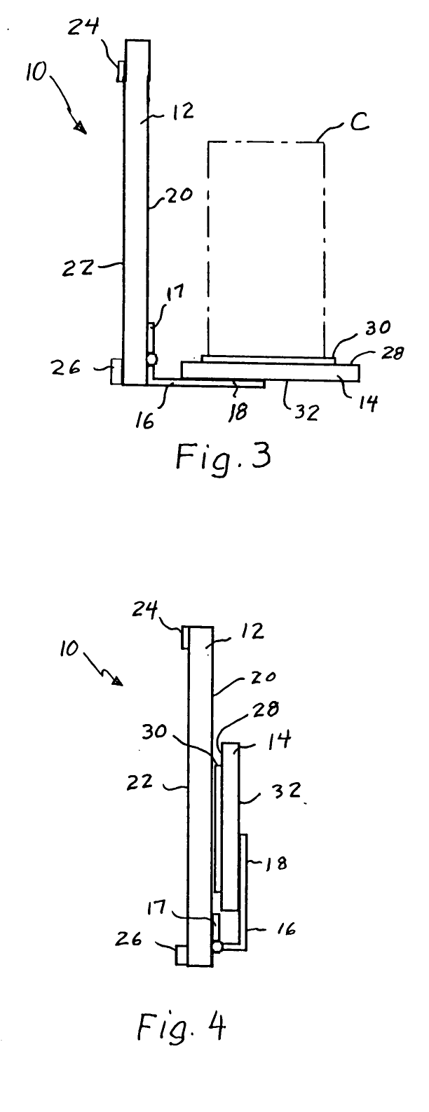

As shown in FIGS. 1 and 3, inner side 28 of front plate 14 serves as a rest for a cup or other beverage container C in unfolded position. Note that guard 30 serves to maintain container C against accidentally sliding off the surface of front plate 14, thus preventing accidental spilling of the container contents.

While only a preferred embodiment has been described and shown, obvious modifications are contemplated within the scope of this invention, as defined in the following claims.

1. A device providing a place to rest a beverage container, comprising a back plate, means for hanging the back plate on a wall, a front plate hinged at its bottom to the back plate for movement relative thereto between a folded position adjacent the back plate and an unfolded position extending from the back plate, means for enabling the back plate to be hung on a wall, means for assuring that the front plate extends 90° from the back plate in the unfolded position, the front plate having an inner side suitable for serving as a horizontal rest for the beverage container when in unfolded position, and an outer side having means for mounting a picture for display when in the folded position.

2. The device of claim 1, wherein the front plate includes a guard rim for constraining a beverage container placed thereon from sliding off the side of the front plate when the front plate is in unfolded position.

3. The device of claim 1, wherein the outer side of the front plate includes means for mounting a picture.

4. The device of claim 5, wherein the inner side of the back plate includes means for mounting a picture.
